(19) United States
(12) Patent Application Publication
(10) Pub. No.: US 2018/0020024 A1
(43) Pub. Date: Jan. 18, 2018

(54) Methods and Systems for Using Self-learning Techniques to Protect a Web Application

(71) Applicant: QUALCOMM Incorporated, San Diego, CA (US)

(72) Inventors: Hui Chao, San Jose, CA (US); Nayeem Islam, Palo Alto, CA (US); Gheorghe Calin Cascaval, Palo Alto, CA (US)

(21) Appl. No.: 15/417,718

(22) Filed: Jan. 27, 2017

Related U.S. Application Data
(60) Provisional application No. 62/362,530, filed on Jul. 14, 2016.

(51) Int. Cl. H04L 29/06; H04L 12/26; G06F 17/18

(52) U.S. Cl. CPC H04L 63/1491; H04L 63/02; H04L 63/1425; G06F 17/18; H04L 43/0876; H04L 67/42

(57) ABSTRACT

Various embodiments include methods for protecting a web application server from non-benign web application usage. Embodiment methods may include receiving from a client device a service request message that includes information suitable for causing a web application operating on the web application server to perform one or more operations. In response, a processor, such as within the web application server or another network device, may analyze usage of the web application by the client device via a combination of a honeypot component, a sandboxed detonator component, and a Web Application Firewall (WAF) component. Analysis results may be generated by analyzing the received service request message or a server response message sent by the web application server. The analysis results may be used to identify non-benign web application usage. Actions may be taken to protect the web application server and/or the client device from the identified non-benign web application usage.

### RELATED APPLICATIONS

This application claims the benefit of priority to U.S. Provisional Application No. 62/362,530, entitled “Methods and Systems for Using Self-learning Techniques to Protect a Web Application” filed Jul. 14, 2016, the entire contents of which is hereby incorporated by reference.

### BACKGROUND

Internet and web technologies have seen explosive growth over the past several years. The web has been embraced by millions of businesses as an inexpensive channel to communicate and exchange information with prospects and transactions with customers. Web applications offer a wide array of features and services that provide their users with unprecedented levels of access to information, resources and communications. Most organizations today operate on the web, and need to protect their applications, business and users from various risks.

### SUMMARY

The various embodiments include methods of protecting a web application server from non-benign web application usage, which may include a processor in a server computing device receiving from a client device a service request message that includes information suitable for causing a web application operating on the web application server to perform one or more operations, analyzing the usage of the web application by the client device (or web application usage) via two or more components selected from a group that includes a honeypot component, a sandboxed detonator component, and a Web Application Firewall (WAF) component in order to generate analysis, generating additional analysis results by analyzing the received service request message or a server response message sent by the web application server, using any or all of generated analysis results to identify the non-benign web application usage, and performing various actuation operations for protecting the web application server from the non-benign web application usage.

In an embodiment, analyzing the usage of the web application via the two or more components may include determining via the WAF component whether a web application usage associated with the received service request message is an outlier usage, analyzing the outlier usage via the honeypot component to compute a probability value that identifies a likelihood that the outlier usage is non-benign, determining via the honeypot component whether the computed probability value exceeds a threshold value, analyzing the outlier usage via a sandboxed detonator component in response to determining that the computed probability value exceeds the threshold, and analyzing the outlier usage via the WAF component in response to determining that the computed probability value does not exceed the threshold. In a further embodiment, protecting the web application server from the non-benign web application usage may include protecting the web application server based on analysis results generated by either the sandboxed detonator or the WAF component.

In an embodiment, the WAF component may include a behavior based security component. In a further embodiment, analyzing the usage of the web application by the client device via the combination of the honeypot component, the sandboxed detonator component, and the WAF component may include monitoring service request messages received from the client device, monitoring responses sent by the web application server, monitoring context information of the web application as it operates in a target computing environment, collecting behavior information from the web application, analyzing the collected behavior information to recognize outlier usage of the web application, and analyzing the outlier usage of the web application via the honeypot component in response to determining that the usage of the web application is an outlier.

In a further embodiment, analyzing the usage of the web application by the client device via the combination of the honeypot component, the sandboxed detonator component, and the WAF component may include routing the service request message to the honeypot component in response to determining that web application usage is an outlier usage that has a probability of being non-benign that exceeds a threshold. In a further embodiment, the honeypot component may include a replica of a target computing environment, and the method may further include exercising the web application in the replica of the target computing environment included in the honeypot component.

In a further embodiment, the method may include surreptitiously monitoring the web application as it operates in the replica of the target computing environment. In a further embodiment, analyzing the usage of the web application by the client device via the combination of the honeypot component, the sandboxed detonator component, and the WAF component may include confirming that web application usage is non-benign via the sandboxed detonator component. In a further embodiment, the method may include coordinating, via a manager component, operations and interactions between the honeypot component, the WAF component, and the sandboxed detonator component.

Further embodiments may include a system that includes a web application server, a honeypot component, a sandboxed detonator component, and a Web Application Firewall (WAF) component, in which one or more of the honeypot component, the sandboxed detonator component, and the WAF component are configured to perform operations that include analyzing a usage of a web application by a client device, generating analysis results by analyzing the received service request message or a server response message sent by the web application server, using the generated analysis results to identify non-benign web application usage, and protecting the web application server from the non-benign web application usage. In some embodiments, the WAF component may include a behavior based security component.

In an embodiment, the system may be configured such that analyzing the usage of the web application via the two or more components includes determining via the WAF component whether a web application usage associated with the received service request message is an outlier usage, analyzing the outlier usage via the honeypot component to compute a probability value that identifies a likelihood that the outlier usage is non-benign, determining via the honeypot component whether the computed probability value exceeds a threshold value, analyzing the outlier usage via a sandboxed detonator component in response to determining that the computed probability value exceeds the threshold, and analyzing the outlier usage via the WAF component in response to determining that the computed probability value does not exceed the threshold. In a further embodiment, the system may be configured such that protecting the web application server from the non-benign web application usage includes protecting the web application server based on analysis results generated by either the sandboxed detonator component or the WAF component.

In a further embodiment, the system may be configured such that analyzing the usage of the web application by the client device may include monitoring service request messages received from the client device, monitoring responses sent by the web application server, monitoring context information of the web application as it operates in a target computing environment, collecting behavior information from the web application, analyzing the collected behavior information to recognize outlier usage of the web application, and analyzing the outlier usage of the web application via the honeypot component in response to determining that the usage of the web application is an outlier. In a further embodiment, the system may be configured such that analyzing the usage of the web application by the client device includes routing a service request message to the honeypot component in response to determining that web application usage is an outlier usage that has a probability of being non-benign that exceeds a threshold. In a further embodiment, the honeypot component includes a replica of a target computing environment, and one or more of the honeypot component, the sandboxed detonator component, and the WAF component may be configured to perform operations including exercising the web application in the replica of the target computing environment included in the honeypot component. In a further embodiment, the system may be configured to surreptitiously monitor the web application as it operates in the replica of the target computing environment.

Further embodiments may include a computing device that includes means for analyzing a usage of a web application by a client device, means for generating analysis results by analyzing the received service request message or a server response message sent by a web application server, means for using the generated analysis results to identify non-benign web application usage, and means for protecting the web application server from the non-benign web application usage.

In an embodiment, means for analyzing usage of the web application by the client device may include means for determining, via the WAF component, whether a web application usage associated with the received service request message is an outlier usage, means for analyzing via the honeypot component the outlier usage to compute a probability value that identifies a likelihood that the outlier usage is non-benign, means for determining via the honeypot component whether the computed probability value exceeds a threshold value, means for analyzing the outlier usage via a sandboxed detonator component in response to determining that the computed probability value exceeds the threshold, and means for analyzing the outlier usage via the WAF component in response to determining that the computed probability value does not exceed the threshold. In a further embodiment, means for protecting the web application server from the non-benign web application usage includes means for protecting the web application server based on analysis results generated by either the sandboxed detonator or the WAF component.

In an embodiment, means for analyzing usage of the web application by the client device may include means for analyzing usage of the web application by the client device via two or more components selected from a group that includes a honeypot component, a sandboxed detonator component, and a Web Application Firewall (WAF) component, the WAF component including a behavior based security component. In an embodiment, means for analyzing usage of the web application by the client device may include means for monitoring service request messages received from the client device, means for monitoring responses sent by the web application server, means for monitoring context information of the web application as it operates in a target computing environment, means for collecting behavior information from the web application, means for analyzing the collected behavior information to recognize outlier usage of the web application, and means for analyzing outlier usage of the web application via a honeypot component in response to determining that the usage of the web application is an outlier.

In an embodiment, means for analyzing usage of the web application by the client device may include means for routing a service request message to a honeypot component in response to determining that web application usage is an outlier usage that has a probability of being non-benign that exceeds a threshold value. In a further embodiment, the computing device may include means for exercising the web application in a replica of a target computing environment included in a honeypot component. In a further embodiment, the computing device may include means for surreptitiously monitoring the web application as it operates in the replica of the target computing environment. In a further embodiment, means for analyzing usage of the web application by the client device may include means for confirming that web application usage is non-benign via a sandboxed detonator component. In a further embodiment, the computing device may include means for coordinating, via a manager component, operations and interactions between a honeypot component, a WAF component, and a sandboxed detonator component.

Further embodiments may include non-transitory processor-readable medium having stored thereon processor-executable instructions configured to cause a processor of a computing device to perform operations that may include analyzing a usage of a web application by a client device, generating analysis results by analyzing the received service request message or a server response message sent by a web application server, using the generated analysis results to identify non-benign web application usage, and protecting the web application server from the non-benign web application usage.

In an embodiment, the stored processor-executable instructions may be configured to cause a processor to perform operations such that analyzing the usage of the web application includes analyzing the usage of the web application via two or more components selected from a group that includes a honeypot component, a sandboxed detonator component, and a Web Application Firewall (WAF) component, the WAF component including a behavior based security component. In a further embodiment, the stored processor-executable instructions may be configured to cause a processor to perform operations such that analyzing the usage of the web application further includes monitoring service request messages received from the client device, monitoring responses sent by the web application server, monitoring context information of the web application as it operates in a target computing environment, collecting behavior information from the web application, analyzing the collected behavior information to recognize outlier usage of the web application, and analyzing the outlier usage of the web application via a honeypot component in response to determining that the usage of the web application is an outlier.

In a further embodiment, the stored processor-executable instructions may be configured to cause a processor to perform operations such that analyzing the web application includes routing a service request message to a honeypot component in response to determining that web application usage is an outlier usage that has a probability of being non-benign that exceeds a threshold. In a further embodiment, the stored processor-executable instructions may be configured to cause a processor to perform operations further including exercising the web application in a replica of a target computing environment included in a honeypot component.

In a further embodiment, the stored processor-executable instructions may be configured to cause a processor to perform operations further including surreptitiously monitoring the web application as it operates in the replica of the target computing environment. In a further embodiment, the stored processor-executable instructions may be configured to cause a processor to perform operations such that analyzing the web application includes confirming that web application usage is non-benign via a sandboxed detonator component. In a further embodiment, the stored processor-executable instructions may be configured to cause a processor to perform operations further including coordinating, via a manager component, operations and interactions between a honeypot component, a WAF component, and a sandboxed detonator component.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a block diagram illustrating components and information flows in an embodiment system that is configured to protect a corporate network and its devices in accordance with various embodiments.

FIG. 2 is a process flow diagram illustrating a method of protecting a web application (server or service) from non-benign usage or client in accordance with an embodiment.

FIG. 3 is a process flow diagram illustrating a method of protecting web application (or server or service) from non-benign usage or client in accordance with another embodiment.

FIG. 4 is a component block diagram of a web application (server or service) suitable for use with various embodiments.

FIG. 5 is a component block diagram of a server device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, various embodiments include systems, methods, and computing devices configured to implement the methods, for protecting a web application server from non-benign web application usage. A server computing system may be configured to receive from a client device a service request message that includes information suitable for causing a web application operating on the web application server to perform operations, engage in an activity, display a behavior, etc. The server computing system may analyze the usage of the web application by the client device via a combination of (e.g., two or more of) a honeypot component, a sandboxed detonator component, and a Web Application Firewall (WAF) component. As part of these operations, the server computing system may analyze received service request messages, server response messages, and contextual information to generate analysis results and determine whether the web application usage (e.g., operations performed in response to receiving the service request message, etc.) is non-benign. The server computing system may use this information and/or the generated analysis results to protect the web application server from web application usage that is non-benign.

The various embodiments improve the performance and functioning of the network and its computing devices by using a combination of honeypot, sandboxed detonator, and WAF components to analyze web application usage. For example, this combination of components may allow a server computing device to more efficiently generate more accurate analysis results that better identify non-benign web application usage, allowing the computing device to better protect web application servers from non-benign web application usage. Additional improvements to the performance and functioning of the computing devices will be evident from the disclosures below.

The phrase “web application usage” is used herein to refer to the specific way in which a web application is used by a client application (e.g., or client device, end-user, etc.), which may be controlled, determined, or caused by the client including specific types of information in a service request message and/or by sending specific types of request messages as a series of HTTP requests to specific destinations in the network (e.g., to a web application server, etc.). Each “web application usage” may be benign or non-benign. As an example, a “benign web application usage” may include a client device sending a service request message that causes the web application to perform one of its advertised services. On the other hand, a “non-benign web application usage” may include a client device sending a service request message that triggers or exploits a vulnerability in the web application, such as to cause the web application to launch a cyberattack or engage in nefarious activities, or send out unauthorized data.

The phrase “web application” is used herein to refer to a client—server software application program that is hosted on a server or a cluster of servers. Unlike conventional or mobile “apps,” each web application may be required to offer, manage, service or serve a multitude of different users, clients, functionalities, services, or web application usages concurrently, in parallel, or within a very short period of time. Typically most of these usages will be benign, however, some usages may be non-benign. As such, a web application executing on a web application server could be required to receive a multitude of service requests (corresponding to usages), and quickly determine whether each of the received service requests (or the corresponding usage) is benign or non-benign. For these and other reasons, a “web application” is fundamentally different from conventional and mobile “apps.”

The phrase “application server” may be used herein to refer to a software framework that provides both the facilities to create a web-based application and a server environment to run the web applications.

The phrase “web application server” may be used in this application to refer to a component (e.g., a server computing device, a cluster of server computing devices, a process executing on a server computing device, etc.) that provides the facilities to create a web-based application and/or a server environment to run the web applications. In some embodiments, a web application server may be a server computing device that includes processing capabilities, storage capabilities, and networking capabilities. The networking capabilities may include network transceiver(s) and antenna(s) configured to establish a wide area network (WAN) connection (e.g., a cellular network connection, etc.) and/or a local area network (LAN) connection (e.g., a wired/wireless connection to the Internet via a Wi-Fi router, etc.). The processing capabilities may include a hardware processor that is configured with processor executable instructions to perform, execute, or run web applications or application servers. A web application server may also be configured to offer or provide a specific suite of services to client computing device (“users”).

The term “honeypot” is used herein to refer to a component that is configured to purposefully elicit probes and attacks from attackers in order to detect, identify, and characterize such attacks. A honeypot component may include an isolated and lightweight mirror/replica of a target computing environment (e.g., an emulator, etc.). The honeypot component may also include a processor that is configured to present or advertise various combinations of services, resources, capabilities and functionalities for web application usage that may attack a malicious process or network probe. The honeypot component may advertise the resources (or capabilities, functionalities, etc.) in a manner that is predicted to encourage non-benign web application usages and/or predicted to encourage clients or users to launch cyberattacks or otherwise engage in non-benign activities or behaviors. Honeypot components are discussed in more detail further below.

Phrases such as “performance degradation,” “degradation in performance” and the like are used in this application to refer to a wide variety of undesirable operations and characteristics of a network or computing device, such as longer processing times, slower real time responsiveness, lower battery life, loss of private, sensitive or unauthorized data, malicious economic activity (e.g., sending unauthorized data), denial of service (DoS), poorly written or designed software/web applications, malicious software, malware, viruses, fragmented memory, injection flaws such as Structured Query Language (SQL), operating system (OS), and Lightweight Directory Access Protocol (LDAP) injections that occur when untrusted data is sent to an interpreter as part of a command or query, hostile data (which can trick an interpreter into executing unintended commands or accessing data without proper authorization), operations relating to commandeering the device or utilizing the device for spying or botnet activities, etc. Also, behaviors, activities, and conditions that degrade performance for any of these reasons are referred to in this application as “not benign” or “non-benign.”

A conventional anomaly detection solution may implement and use unsupervised learning techniques to protect a computing device from malware and non-benign web application usage. For example, a computing device may be configured to monitor a web application usage (or a software/web application as it executes on the device) in order to identify its operating patterns (e.g., usage patterns, behavior patterns, etc.). The computing device may compare the identified patterns to known patterns of benign or non-benign behavior. The computing device may determine whether the web application usage (or a corresponding client, a monitored software/web application, etc.) is non-benign based on a result of the comparison.

Conventional solutions that only compare the identified patterns to known patterns of non-benign behavior (i.e., solutions that look for bad behaviors, etc.) are limited to detecting known malware and viruses. Further, malicious web application usage (or malicious client application, device, end-user, etc.) can evade detection by such solutions by changing or masking their operations. Therefore, in order to adequately protect the computing devices in the enterprise or corporate network, many conventional unsupervised learning solutions compare the identified operating patterns to known patterns of benign behavior (i.e., they look for approved behaviors). Yet, modern computing devices are complex systems, and there are many benign behaviors that each software application may exhibit on the computing device. As a result, unsupervised learning solutions that compare the identified operating patterns to known patterns of benign behavior (i.e., solutions that look for approved behaviors) often inadvertently prevent or restrict a relatively large number of benign web application usage (e.g., prevent the web application from providing its advertised functionality, servicing benign service requests, etc.). Preventing benign users or clients from accessing or using the web application in accordance with its advertised functionality may degrade the user experience. For these and other reasons, conventional unsupervised learning solutions have significant limitations in securing modern computing devices or corporate networks.

A conventional anomaly detection solution could implement and use supervised learning techniques to reduce the number false positives (and thus the number of benign applications that are inadvertently restricted by the device). For example, a computing device could monitor a software application to determine its operating patterns, compare the determined operating patterns to known benign or non-benign operating patterns, determine whether the determined operating patterns are consistent with normal operating patterns, and classify the software application as abnormal or suspicious in response to determining that the operations are not consistent with the normal operating patterns. The computing device could then temporality prevent abnormal or suspicious applications from executing on the device. The computing device could send the collected behavior information (or information identifying the suspicious applications or behaviors) to a human analyzer for further evaluation. The human analyzer could determine whether the software application is benign or non-benign, label or categorize the software application, and update the known patterns of benign and non-benign behaviors. The computing device could then use this updated information (e.g., labels, patterns, etc.) to more accurately classify web application usage as benign or non-benign. By using human analysts, the supervised learning solution described above may “learn” new behavior patterns, including syntax of requests from a user and server-based behaviors (e.g., change of access level, throw of exception, application parameters out-of-range, etc.) over time. This improves the accuracy of the anomaly detection solutions, and significantly reduces the number or incidences of false positives over time (compared to unsupervised learning). However, such a solution is extremely labor intensive and slow, and otherwise not suitable for inclusion and use in modern computing devices (e.g., server computing devices that host/include web application servers, etc.).

The various embodiments overcome the above-described limitations of existing and conventional solutions by equipping/configuring a computing system with a multiple components (e.g., a manager component, a honeypot component, a comprehensive security component, and a sandboxed detonator component) that are configured to work in conjunction with one another to implement an automated supervised learning system. The automated supervised learning system may allow the computing device to learn new behavior patterns and label web application usage without human input or intervention. In addition, the automated supervised learning system may allow the computing device to intelligently filter the behaviors/requests/applications/usages that are analyzed by analysis components that monitor/assess a large number of features with complex analysis models and thus provide the more “robust” analysis (and thus are more processor/memory/network bandwidth intensive). Doing so enables the computing device to focus the monitoring and analysis operations on evaluating the features (i.e., elements of behaviors, service requests and/or service responses, etc.) that contribute to a determination of benign/non-benign behavior, avoiding monitoring/analysis of features that contribute little or nothing to that determination.

By automatically learning new behavior patterns and automatically labeling and relabeling web application usage (e.g., data request received from client devices, processes resulting from requests to a web application server, data responses by the web application server, etc.), the various embodiments reduce the number or incidences of false positives without the labor intensive human analysis operations required by other supervised learning solutions. As a result, the various embodiments improve the accuracy of malware detection on the computing device. Further, by using different components to evaluate web applications/web application usage at different levels of complexity, intelligently filtering the behaviors/applications that are analyzed, and focusing the computing device's operations on the most relevant features, the various embodiments allow the computing device to evaluate a web application by monitoring client data requests and server responses, thus evaluating the web application with fewer operations, faster and more efficiently. This improves the performance and power-consumption characteristics of the computing device. For all these reasons, the various embodiments improve the functioning of the computing device.

In an embodiment, the computing system may include a manager component, a honeypot component, a comprehensive security component, and a sandboxed detonator component. In some embodiments, all or portions of the comprehensive security component may be included in, or implemented as part of a Web Application Firewall (WAF). WAFs may be deployed as a collection of standalone physical devices, a hybrid combination of physical devices and virtual components, or as a fully virtualized appliance. In an embodiment, the comprehensive security component may be a WAF engine.

The manager component may be configured to steer web-based requests and web application usage to the honeypot component, comprehensive security component, or sandboxed detonator component. In addition, the manager component may be configured to coordinate the operations and interactions between the honeypot component, comprehensive security component, and sandboxed detonator component. For example, the manager component may be configured to receive information from the comprehensive security component that identifies a web application (or web application usage) as an “outlier,” and steer that application to the honeypot component to determine the likelihood of it being malicious. As another example, the manager component may receive information from the honeypot component that indicates that the probability that a web application (or web application usage) is malicious exceeds a threshold (e.g., more likely than not), and steer that application to the sandboxed detonator component for a more robust evaluation and/or for a more accurate determination of whether the application (or web application usage) is non-benign.

The honeypot component may be configured to purposefully elicit probes and attacks from attackers in order to find, identify, and characterize such attacks. For example, the honeypot component may include an isolated and lightweight mirror/replica of a target computing environment, and present various combinations of resources, capabilities and functionalities to web application usage (or their corresponding servers, web-based request messages, processes, etc.) in a manner that is predicted to encourage non-benign web application clients and usages to launch cyberattacks or otherwise engage in non-benign behaviors.

The manager component may steer selected web-based requests and web applications (or web application usage) to the honeypot component for execution in the replicated environment. For example, the manager component may store a list of servers that previously scanned the target environment for unused IP addresses or open sockets. The manager component may detect that a web-based request or web application originates from a server included in the list, and steer that request/application to the honeypot component for execution in the replicated environment.

The honeypot component may include well-disguised monitoring and analysis components that covertly or surreptitiously monitor the web application (or server, actor, request, traffic, usage, etc.) as it executes or operates in the replicated environment. The honeypot component may collect behavior and exchanged information (e.g., requests and responds, data requests received from client devices, information generated by processes resulting from requests to a web application server, data responses by the web application server, etc.) of user and server from the monitored application, and analyze the collected information to determine the probability or likelihood that a user session (or http session, client, actor, request, etc.) is malicious or non-benign. The honeypot component may inform the manager component of the probability that the evaluated session, or the usage of an application (or request, behavior, etc.), is malicious or non-benign. For example, the honey pot component may send the manager component a communication message that includes a probability value that identifies the likelihood that an evaluated session (or usage, etc.) is non-benign.

The comprehensive security component (or WAF) may be configured to use supervised learning, unsupervised learning, dynamic analysis, behavioral analysis, and/or machine learning techniques to detect, identify, classify, prevent, and/or respond to malware and other non-benign behaviors of an attack. For example, in an embodiment, the comprehensive security component may be configured to monitor the requests (e.g., service request messages, web-based requests, scripts embedded in received requests, command variables and values, etc.), responses and the associated context information (e.g., time, time interval, IP address, data sizes, etc.) of a web application (target environment) to collect behavior information. The comprehensive security component may compare the collected information to known patterns of benign or non-benign behavior to determine whether a monitored behavior (e.g., behavior resulting from the activities of the software/web application on the computing device, etc.) is consistent with the expected or normal operating patterns of an application. The comprehensive security component may label or mark application usage (or user's request, an http session, web-based request, client behavior, activity, etc.) as an “outlier” in response to determining that an associated behavior (e.g., behavior resulting from the web application's activities on the device, etc.) is not consistent with the normal or expected operating patterns. The comprehensive security component may inform the manager component that the web application usage (or web-based request, behavior, etc.) is an outlier that requires further evaluation.

As another example, in an embodiment, the comprehensive security component may be a behavior based security component that is configured to monitor the operations (requests, responds and context information) or activities of a user or the web application to collect behavior information, use the collected behavior information to generate a user/server behavior vector (e.g., an information structure that stores a series of numerical values that collectively characterize a monitored behavior, etc.), apply the generated behavior vector to a machine learning classifier model (e.g., an information structure that includes decision nodes that each evaluate a device feature or test a condition, etc.) to generate behavior analysis results, and use the behavior analysis results to classify user requests as benign, suspicious or non-benign. The comprehensive security component may label or mark a user, a client, an http session, a user session, or a web application usage classified as suspicious as an “outlier” case that requires further analysis, and inform the manager component of outlier web application usage(s) that require further evaluation.

The sandboxed detonator component may be configured to emulate the computing device and service or target environment in separate, isolated and robust execution environment. The sandboxed detonator component may exercise or stress test a web application through a large number of configurations, operations and user requests and interactions. The sandboxed detonator component may monitor the operations and activities of the web application during the exercise/stress testing, and perform various analysis operations (e.g., static analysis operations, dynamic analysis operations, behavior-based analysis operations, etc.) to determine whether a web application usage (application execution upon user's requests) is benign, suspicious, or non-benign. The comprehensive security component may inform the manager component of suspicious web application usage (or requests, behaviors, activities, etc.) that require close monitoring or further evaluation by the sandboxed detonator component.

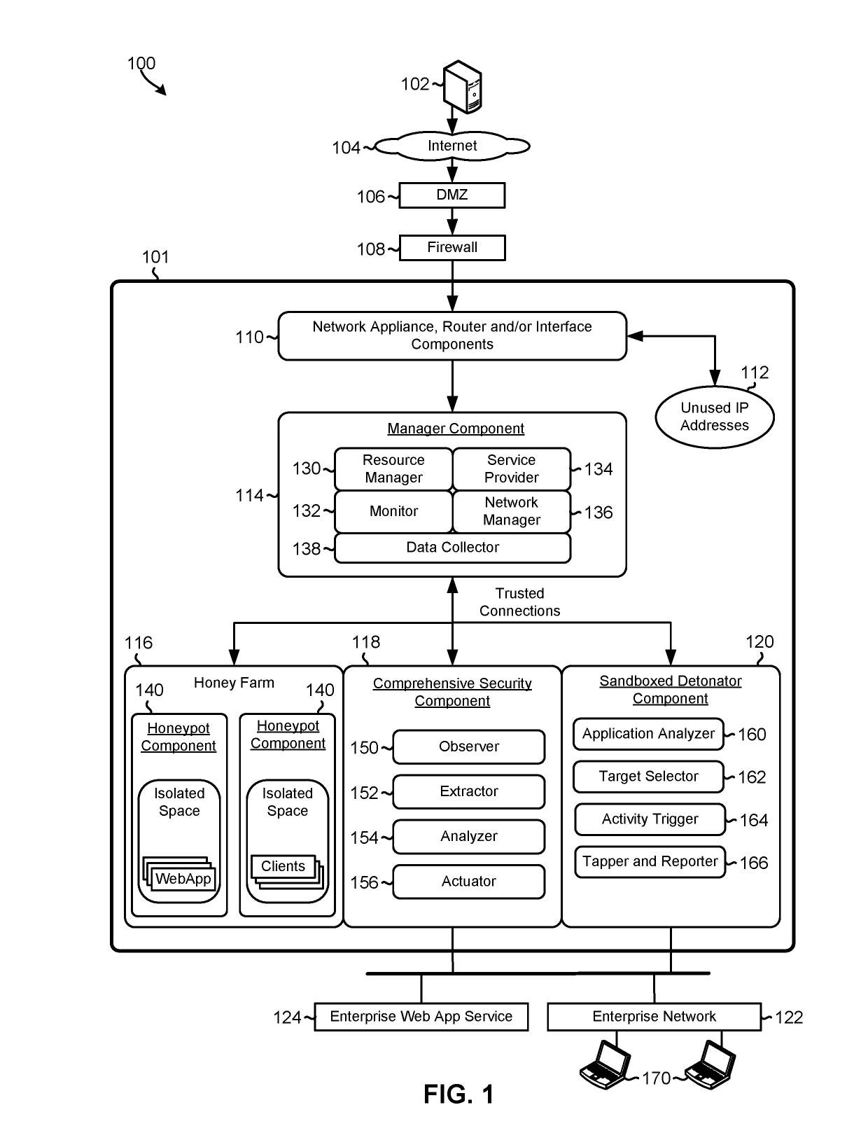

FIG. 1 illustrates various components and communication links in a system 100 that includes a computing system 101 that is configured to detect and respond to non-benign web application usage in accordance with the various embodiments. In the example illustrated in FIG. 1, the system 100 includes a network server 102, demilitarized zone (DMZ) 106, firewall 108, computing system 101, enterprise web application service or servers 124 and an enterprise network 122 to which client devices 370 may connect. The network server 102 may include any remote server that could be accessed via the Internet 104, such as by applications running on client devices 170. The DMZ 106 and firewall 108 may be any well-known security components that are standard equipment used to protect networks and computing systems (e.g., 101).

The computing system 101 may include standard network appliance, router and/or interface components 110 used to receive incoming data packets from remote servers 102, direct incoming data packets to the addressed client devices 170 via the enterprise network 122, receive outgoing data packets from client devices via the enterprise network and relay the outgoing data packets via the Internet 104.

The computing system 101 may include a manager component 114 configured to supervise operations of enterprise network 122, manage resources, and collect data regarding network operations. The manager component 114 may include a resource manager 130 configured to keep track of resources of the computing system 101 and the enterprise network 122, and manage their utilization by various components and client devices 170. The manager component 114 may include a network manager 136 configured to manage operations of the enterprise network 122. The manager component 114 may include a monitor component 132 configured to monitor data flows and access requests within computing system 101 and the enterprise network 122 and provide such information to the resource manager 130, the network manager 136 and/or a data collector 138 configure to save data regarding network operations. The manager component 114 may also include a service provider 130 configured to supervise the provision of services to client devices 170 via the enterprise network 122, including services provided by an enterprise web application service 124.

The computing system 101 may include a honey farm 116. The honey farm 116 may include one or more honeypot components 140. Each of the honeypot components 140 may include an isolated space suitable for executing one or more web/software server applications and or client applications. In some embodiments, the isolated space may include a lightweight mirror/replica of the operating environment of the computing system 101. The honey farm 116 may also be configured to present various combinations of resources, capabilities and functionalities to web application server (or servers, web-based requests, etc.) in a manner that is predicted to encourage non-benign applications or usage to launch cyberattacks or otherwise engage in non-benign behaviors.

The computing system 101 may include a comprehensive security component 118. The comprehensive security component 118 may be configured to receive a web application from the manager component 114, execute the web application, monitor the behaviors of the web application usage to collect behavior information, and analyze the collected behavior information to determine whether the web application is benign, suspicious or non-benign. In some embodiments, comprehensive security component 118 may generate a vector data structure that describes the collected behavior information via a plurality of numbers or symbols, apply the vector data structure to a machine learning classifier model to generate an analysis result, and use the generated analysis result to determining whether the usage of web application is benign, suspicious or non-benign. In response to determining that the usage of web application is suspicious (or an “outlier”), the comprehensive security component 118 may collect and send additional behavior information to the manager component 114 for use by a honeypot component 140 or the sandboxed detonator component 120.

The computing system 101 may include a sandboxed detonator component 120. The sandboxed detonator component 120 may be configured to receive a web application from the manager component 114, establish a secure communication link to honeypot component 140 within the honey farm 116 and/or a client computing device 170, and receive exercise information from the manager component 114, a honeypot component 140, and/or the client computing device 170. Examples of exercise information include information identifying a confidence level for the web application, a list of explored activities such as HTTP requests, a list of explored html pages, a list of unexplored activities, a list of unexplored html pages, a list of unexplored behaviors, hardware configuration information, software configuration information, etc. The sandboxed detonator component 120 may use the received exercise information to exercise/execute the received web application in a sandboxed emulator or a honeypot component 140 to identify one or more behaviors, trigger a sequence of activities that will lead to a desired behavior or trigger identified behaviors, observe behaviors of the emulator when the identified behaviors are triggered, and determine whether the web application and/or identified behaviors are benign. The sandboxed detonator component 120 may also compute a risk score for the received web application, and send the computed risk score to the manager component 114 via the secure or trusted communication links.

In an embodiment, the comprehensive security component 118 may include a behavior observer component 150, a behavior extractor component 152, a behavior analyzer component 154, and an actuator component 156.

The behavior observer component 150 may be configured to instrument or coordinate various application programming interfaces (APIs), registers, counters or other components (herein collectively “instrumented components”) at various levels of an enterprise web application (app) server 124 or services. The behavior observer component 150 may repeatedly or continuously (or near continuously) monitor activities of the client computing device 170 by collecting behavior information from the instrumented components. In an embodiment, this may be accomplished by reading information from API or system log files stored in a memory of the client computing device 170.

The behavior observer component 150 may communicate (e.g., via a memory write operation, function call, etc.) the collected behavior information to the behavior extractor component 152, which may use the collected behavior information to generate behavior information structures that each represent or characterize many or all of the observed behaviors that are associated with a specific web application usage, a time sequence of client HTTP requests and server responses, an http session, a user session, etc. Each behavior information structure may be a behavior vector that encapsulates one or more “behavior features.” Each behavior feature may be an abstract number that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used.

The behavior extractor component 152 may communicate (e.g., via a memory write operation, function call, etc.) the generated behavior information structures to the behavior analyzer component 154. The behavior analyzer component 154 may apply the behavior information structures to classifier models to generate analysis results, and use the analysis results to determine whether a usage of a web application or service behavior is benign or non-benign (e.g., malicious, poorly intended, performance-degrading, etc.).

The behavior analyzer component 154 may be configured to notify the actuator component 156 that an activity or behavior is not benign. In response, the actuator component 156 may perform various actions or operations to heal, cure, isolate, or otherwise fix identified problems. For example, the actuator component 156 may be configured to deny a web application or process request when the result of applying the behavior information structure to the classifier model (e.g., by the analyzer module) indicates that a usage of web application or process is not benign.

The behavior analyzer component 154 also may be configured to notify the behavior observer component 150 in response to determining that a usage or client behavior is suspicious (i.e., in response to determining that the results of the analysis operations are not sufficient to classify the behavior as either benign or non-benign). In response, the behavior observer component 150 may adjust the granularity of its observations (i.e., the level of detail at which client request and server response features are monitored) and/or change the factors/behaviors that are observed based on information received from the behavior analyzer component 154 (e.g., results of the real-time analysis operations), generate or collect new or additional behavior information, and send the new/additional information to the behavior analyzer component 154 for further analysis. Such feedback communications between the behavior observer and behavior analyzer components 150, 154 enable the client computing device processor to recursively increase the granularity of the observations (i.e., make finer or more detailed observations) or change the features/behaviors that are observed until behavior is classified as either benign or non-benign, until a processing or response time threshold is reached, or until the analyzer determines that the source of the suspicious or performance-degrading behavior cannot be identified from further increases in observation granularity.

In an embodiment, the sandboxed detonator component 120 may include an application analyzer component 160, a target selector component 162, an activity trigger component 164, a tapper and reporter component 166.

The application analyzer component 160 may be configured to perform static and/or dynamic analysis operations to identify one or more behaviors and determine whether the identified behaviors are benign or non-benign. For example, for each activity in an http or user session on the web application (e.g., authentication of user, database access, memory read and write, network access, etc.), the application analyzer component 160 may perform any of a variety of operations, such as count the number of requests, extract triggered and embedded scripts in the request, extract associated variable and values, check authentication level, detect amount and type of data access to the database, record changes in system memory, record usage of computing resources, number of network accesses, detect type and amount of data sent through network, count the number of sensitive/interesting API or system calls, examine its corresponding scripts, call methods to unroll scripts code or operations/activities, examine the resulting source script code, recursively count the number of lines of code, recursively count the number of sensitive/interesting API or system calls, etc. The application analyzer component 160 may also be used to generate the activity transition graph for the given application that captures how the different activities (i.e., web pages) are linked to one another.

The target selection component 162 may be configured to identify and select high value target activities (e.g., according to the use case, based on heuristics, based on the outcome of the analysis performed by the application analyzer component 160, as well as the exercise information received from the client computing device, etc.). The target selection component 162 may also rank activities or activity classes according to the amount of system damage and data losses, such as the server being taken over, serious data loss, data corruption on the server, a user gaining access to sensitive or unauthorized data and any backups of that data, the increased workload, memory load, network traffic load on the server, etc. Examples of malicious usage may include SQL injection, cross-site scripting, etc. The target selection component 162 may also prioritize visiting of activities according to the ranks, and select the targets based on the ranks and/or priorities.

Once the current target activity is reached and explored, a new target may be selected by the target selection component 162. In an embodiment, this may be accomplished by comparing the number of sensitive/interesting API calls that are actually made during runtime with the number of sensitive/interesting API calls that are determined by the application analyzer component 160. Furthermore, based on the observed runtime behavior exhibited by the application, some of the activities (including those that have been explored already) may be re-ranked and explored/exercised again on the emulator.

Based on the activity transition graph determined in the application analyzer component 160, the activity trigger component 164 may determine how to trigger a sequence of activities that will lead to the selected target activities, identify entry point activities from the manifest file of the application, for example, and/or emulate, trigger, or execute the determined sequence of activities using the Monkey tool.

The trapper and reporter component 166 may be configured to trap or cause a target behavior. In some embodiments, this may include monitoring activities of the web application to collect behavior information, using the collected behavior information to generate behavior vectors, applying the behavior vectors to classifier models to generate analysis results, using the analysis results to determine the user activity, the user session or http session, label behaviors or vectors as benign or non-benign, send the labeled (benign or non-benign) behavior vector(s) to a comprehensive security component (or WAF component) as labeled training data for further supervised learning.

Each behavior vector may be a behavior information structure that encapsulates one or more “behavior features.” Each behavior feature may be an abstract number that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used. As an example, the tapper and reporter component 166 may generate a behavior vector that includes a “authentication token or cookie” data field whose value identifies or authenticates the access of data information. This allows the tapper and reporter component 166 to analyze this execution state information independent of and/or in parallel with the other observed/monitored activities of the web application. Generating the behavior vector in this manner also allows the system to aggregate information (e.g., frequency or rate) over time.

A classifier model may be a behavior model that includes data and/or information structures (e.g., feature vectors, behavior vectors, component lists, decision trees, decision nodes, etc.) that may be used by the computing device processor to evaluate a specific feature or embodiment of the device's behavior. A classifier model may also include decision criteria for monitoring and/or analyzing a number of features, factors, data points, entries, APIs, states, conditions, behaviors, computing, memory, network usage, processes, operations, components, etc. (herein collectively referred to as “features”) in the computing device.

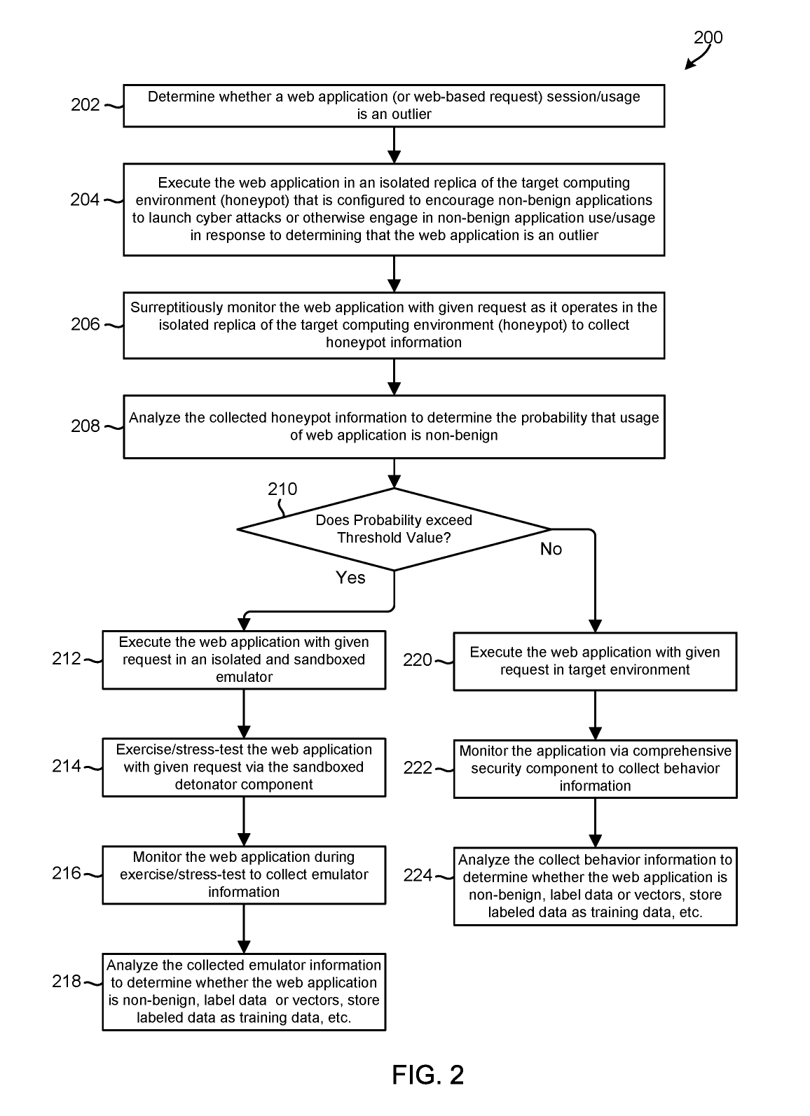

FIG. 2 illustrates a method 200 of protecting computing devices from non-benign web application usage in accordance with an embodiment. The method 200 may be performed by a processor or processing core in a computing device. In block 202, the processor may determine whether a web application request, usage or session is an outlier. In some embodiments, the processor may analyze collected behavior information to recognize outlier usage of a web application corresponding to a received web application request in block 202.

In block 204, the processor may execute the web application with given requests (e.g., service request messages) in an isolated replica of the target computing environment (of a honeypot component or honey farm) that is configured to encourage non-benign usages/clients to launch cyberattacks or otherwise engage in non-benign behaviors. In some embodiments, the processor may be configured to execute the web application in the isolated replica of the target computing environment in response to the processor determining that the web application requests, intention, or session is an outlier (or in response to identifying outlier usage of a web application).

In block 206, the processor may surreptitiously monitor the web application with given requests as it operates in the isolated replica of the target computing environment (honeypot) to collect honeypot information. In block 208, the processor may analyze the collected honeypot information to determine the probability that the usage/client of the web application is non-benign.

In determination block 210, the processor may determine whether the probability that the usage/client of the web application is non-benign exceeds a threshold value.

In response to determining that the probability that usage/client of the web application is non-benign exceeds a threshold value (i.e., determination block 210=“Yes”), the processor may execute the web application with the given requests in an isolated and sandboxed emulator (or via the sandboxed detonator component) in block 212. In block 214, the processor may exercise/stress-test the web application with the given requests via the sandboxed detonator component. In block 216, the processor may monitor the web application with the given requests during the exercise/stress-test to collect emulator information.

In block 218, the processor may analyze the collected emulator information to determine whether the usage/client of the web application is non-benign. In response to determining that the probability that usage/client of the web application is non-benign does not exceed a threshold value (i.e., determination block 210=“No”), the processor may execute the web application with given requests in the primary or target computing environment in block 220. In block 222, the processor may monitor the application via comprehensive security component to collect behavior information. In block 224, the processor may analyze the collected behavior information to determine whether the usage/client of the web application is non-benign.

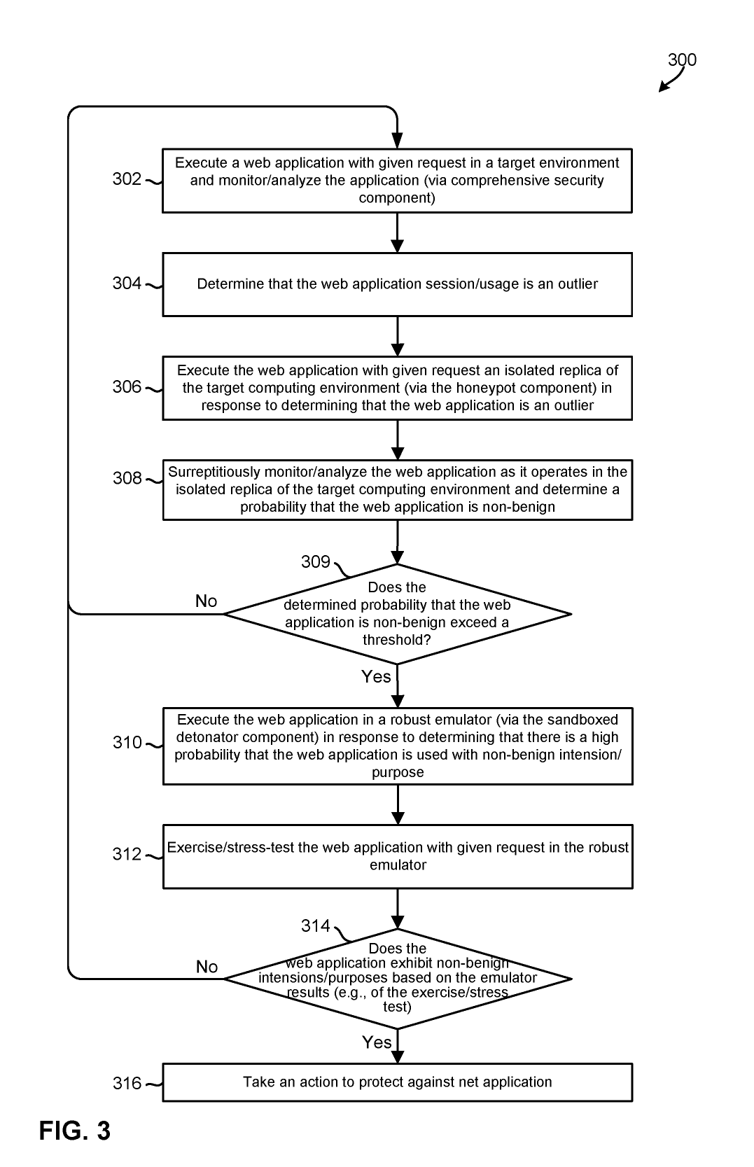

FIG. 3 illustrates a method 300 of protecting computing devices from non-benign web application usage in accordance with another embodiment. The method 300 may be performed by a processor or processing core in a computing device.

In block 302, the processor may execute a web application with the given requests in a primary or target computing environment (via comprehensive security component), monitor the application to collect behavior information, and analyze the collected behavior information to generate analysis results. In block 304, the processor may determine that the usage/client of the web application is an outlier based on the analysis results. In block 306, the processor may execute the web application with the given requests in an isolated replica of the target computing environment (via the honeypot component).

In block 308, the processor may surreptitiously monitor/analyze the web application as it operates in the isolated replica of the target computing environment and determine a probability (e.g., a possibility or likelihood) that the usage/client of the web application is non-benign. For example, this determination may involve analyzing web application behaviors to identify actions, data accesses and behaviors common to non-benign applications. As another example, this determination may include determining whether the web application gains or attempts to access to information that is private or sensitive, and then attempts to communicate the information to an address outside of the network.

In a further example, this determination in block 308 may be accomplished by summarizing observed behaviors in a vector of values (e.g., a “behavior vector”) that is then analyzed by a classifier model that is configured (e.g., through machine learning) to determine a probability that the web application is benign or non-benign. Such a classifier model may be a set of binary decision trees corresponding to values in the behavior vector. The decision criteria in each of the binary decision trees may be determined through machine learning by training the model using a large number of behavior vectors developed for known benign and non-benign applications. The output of applying a behavior vector to such a classifier model may be a value based on the cumulative output of the multiple binary decision trees. Properly trained, an example classifier model may output a value (e.g., between 0 and 1) indicative of a degree of certainty or likelihood (referred to herein as a probability) that the web application is either benign or non-benign.

In determination block 309, the processor may determine whether the probability that the usage/client of the web application is non-benign determined in block 308 exceeds a threshold. In some embodiments, the threshold may a predefined or adjustable level of risk or uncertainty in the benign/non-benign determination at which a protective action should be taken. Varying threshold may enable a network manager to adjust a degree of risk that the network could be victim of a non-benign network application. For example, the threshold may be set at 50 percent so that if a net application is determined to be more likely than not non-benign, the network may take a corrective action. As another example, the threshold may be set higher than 50 percent to reduce the incidence of false positives in which a benign net application may be blocked.

In response to determining that the determined probability that the usage/client of the web application is non-benign does not exceed the threshold (i.e., determination block 309=“No”), the processor may execute another web application in block 302. In response to determining that the determined probability that the usage/client of the web application is non-benign exceeds the threshold (i.e., determination block 309=“Yes”), the processor may execute the web application in a robust emulator (via the sandboxed detonator component) in block 310.

In block 312, the processor may exercise/stress-test the web application with the given requests in the robust emulator (e.g., via the sandboxed detonator component). In determination block 314, the processor may determine whether the web application is non-benign based on the results of exercise/stress-test. In response to determining that the web application is benign (i.e., determination block 314=“No”), the processor may execute another web application in block 302. In response to determining that the web application is non-benign (i.e., determination block 314=“Yes”), the processor may take an action to protect the network from the net application in block 316. In addition, the processor may label the data (or the web application) as benign or non-benign. The processor may also add the labeled data (or data corresponding the web application or analysis results) to training data that may be used to perform supervised learning operations in the next or subsequent round or iteration.

In some embodiments, the processor may be configured to receive (e.g., from a client device) a service request message that includes information suitable for causing a web application operating on a web application server to perform one or more operations. The processor may analyze the usage of the web application (or web application usage) by the client device via a combination of a honeypot component, a sandboxed detonator component, and a Web Application Firewall (WAF) component. In some embodiments, the processor may be configured to route a received service request message to a honeypot component in response to identifying outlier web application usage or determining that a web application usage is an outlier usage that has a probability of being non-benign (a first value) that exceeds a threshold (a second value). In some embodiments, the processor may be configured to exercise the web application in the replica of the target computing environment included in the honeypot component, surreptitiously monitor the web application as it operates in the replica of the target computing environment. The processor may generate analysis results by analyzing the received service request message or a server response message that is sent by the web application server. The processor may use the generated analysis results to identify non-benign web application usage. In some embodiments, the processor may be configured to confirm that the web application usage is non-benign (e.g., via a sandbox). In response to identifying non-benign web application usage, the processor may perform various actuation operations in order to protect the web application server from the non-benign web application usage.

In some embodiments, the processor may be included as part of a system that includes a web application server, a honeypot component, a sandboxed detonator component, and a Web Application Firewall (WAF) component. In some embodiments, the system may also include a manager component that is configured to coordinate the operations and interactions between the honeypot component, the WAF component, and the sandboxed detonator component. The processor(s) may be included in one or more of the honeypot component, the sandboxed detonator component, and/or the WAF component.

In some embodiments, one or more of the web application server, a honeypot component, a sandboxed detonator component, and a Web Application Firewall (WAF) component may include one or more processors that may be configured to perform operations that include analyzing a usage of a web application by a client device, generating analysis results by analyzing the received service request message or a server response message sent by the web application server, using the generated analysis results to identify non-benign web application usage, and protecting the web application server from the non-benign web application usage.

In some embodiments, one or more of the processors may be further configured to perform operations that include monitoring the service request messages that are received from client devices, monitoring the responses (e.g., service response messages) that are sent by the web application server, monitoring context information of the web application as it operates in a target computing environment, collecting behavior information from the web application (e.g., as it executes in the target computing environment, etc.), analyzing the collected behavior information to generate analysis results, using the generated analysis results to identify outlier usage of the web application, and analyzing outlier usage of the web application (e.g., via the honeypot component, etc.) to identify non-benign usage. In some embodiments, a process/processor may be configured to analyze outlier usage in response to identifying outlier usage or determining that the usage of the web application is an outlier.

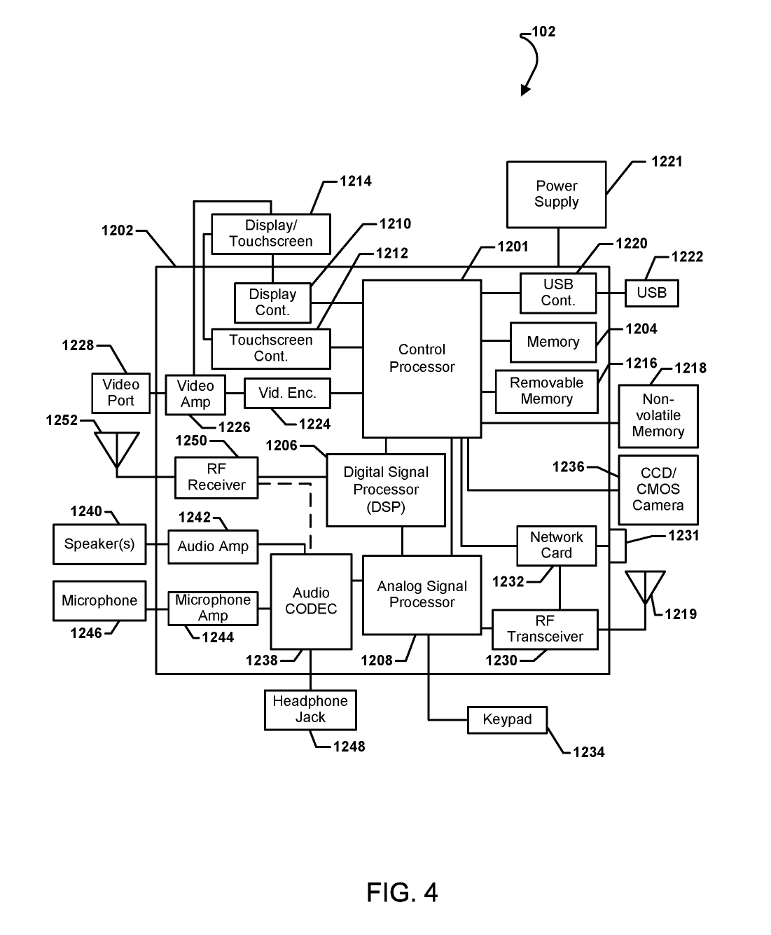

Example components and modules of an exemplary, non-limiting embodiment of a computing device equipped with a web application (server or service) and suitable for use with various embodiments is illustrated in FIG. 4. A computing device 102 may include a circuit board 1202 of electronic components, some or all of which may be integrated into an on-chip system, that includes a control processor 1201 coupled to memory 1204. The control processor 1201 may further be coupled to a digital signal processor 1206 and/or an analog signal processor 1208, which also may be coupled together. In some embodiments, the control processor 1201 and a digital signal processor 1206 may be the same component or may be integrated into the same processor chip. A display controller 1210 and a touchscreen controller 1212 may be coupled to the control processor 1201 and to a display/touchscreen 1214 within or connected to the computing device 102.

The control processor 1201 may also be coupled to removable memory 1216 (e.g., an SD memory or SIM card in the case of mobile computing devices) and/or to external memory 1218, such as one or more of a disk drive, CD drive, and a DVD drive. The control processor 1201 may also be coupled to a Universal Serial Bus (USB) controller 1220 that couples to a USB port 1222. In various embodiments, a power supply 1221 may be coupled to the circuit board 1202 through the USB controller 1220 or through different electrical connections to provide power (e.g., DC power) to the various electronic components.

The control processor 1201 may further be coupled to a network card 1232 which may be coupled to a network connector 1231 and/or the RF transceiver 1230 and configured to enable communications via an external network (e.g., local area networks, the Internet, an intranet, WiFi networks, Bluetooth networks, personal area network (PAN) etc.). The network card 1232 may be in the form of a separate chip or card, or may be implemented as part of the control processor 1201 or the RF transceiver 1230 (or both) as a full solution communication chip.

A number of analog devices may be coupled to the control processor 1201 via the analog signal processor 1208, such as a keypad 1234. In other implementations, a keypad or keyboard may include its own processor so that the interface with the control processor 1201 may be via direct connection (not shown), via a network connection (e.g., via the network card), or via the USB port 1222.

In an embodiment, processor-executable instructions for accomplishing one or more of the method operations described above may be stored in the internal memory 1204, removable memory 1216 and/or non-volatile memory 1218 (e.g., as on a hard drive, CD drive, or other storage accessible via a network). Such processor-executable instructions may be executed by the control processor 1201 in order to perform the methods described herein.

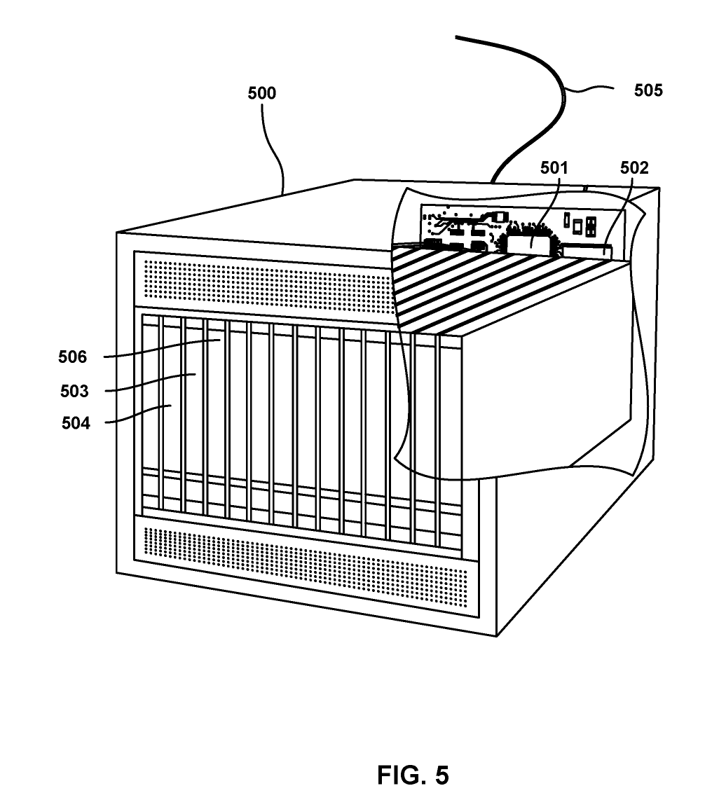

The embodiments and network servers described above may be implemented in variety of commercially available server devices, such as the server 500 illustrated in FIG. 5. Such a server 500 typically includes a processor 501 coupled to volatile memory 502 and a large capacity nonvolatile memory, such as a disk drive 503. The server 500 may also include a floppy disc drive, compact disc (CD) or DVD disc drive 504 coupled to the processor 501. The server 500 may also include network access ports 506 coupled to the processor 501 for establishing data connections 505 with a network, such as a local area network coupled to other communication system computers and servers.

The processors 1201, 501, may be any programmable microprocessor, microcomputer or multiple processor chip or chips that can be configured by software instructions (applications) to perform a variety of functions, including the functions of the various embodiments described below. In some client computing devices, multiple processors may be provided, such as one processor dedicated to wireless communication functions and one processor dedicated to running other applications. Typically, web application usage may be stored in the internal memory before they are accessed and loaded into the processor. Each processor may include internal memory sufficient to store the application software instructions. In some servers, the processor may include internal memory sufficient to store the application software instructions. In some receiver devices, the secure memory may be in a separate memory chip coupled to the processor. The internal memory may be a volatile or nonvolatile memory, such as flash memory, or a mixture of both. For the purposes of this description, a general reference to memory refers to all memory accessible by the processor, including internal memory, removable memory plugged into the device, and memory within the processor.

As used in this application, the terms “component,” “module,” “system” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DPC), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DPC and a microprocessor, a plurality of microprocessors, one or more microprocessors in conjunction with a DPC core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of protecting a web application server from non-benign web application usage, comprising:
receiving from a client device a service request message that includes information suitable for causing a web application operating on the web application server to perform one or more operations;
analyzing a usage of the web application by the client device via two or more components selected from a group comprising a honeypot component, a sandboxed detonator component, and a Web Application Firewall (WAF) component;
generating analysis results by analyzing the received service request message or a server response message sent by the web application server;
using the generated analysis results to identify the non-benign web application usage; and
protecting the web application server from the non-benign web application usage.

2. The method of claim 1, wherein:
analyzing the usage of the web application comprises:
determining, via the WAF component, whether a web application usage associated with the received service request message is an outlier usage;
analyzing, via the honeypot component, the outlier usage to compute a probability value that identifies a likelihood that the outlier usage is non-benign;
determining, via the honeypot component, whether the computed probability value exceeds a threshold value;
analyzing the outlier usage via a sandboxed detonator component in response to determining that the computed probability value exceeds the threshold; and
analyzing the outlier usage via the WAF component in response to determining that the computed probability value does not exceed the threshold; and
protecting the web application server from the non-benign web application usage comprises protecting the web application server based on analysis results generated by either the sandboxed detonator component or the WAF component.

3. The method of claim 1, wherein the WAF component includes a behavior based security component.

4. The method of claim 1, wherein analyzing the usage of the web application by the client device via the combination of the honeypot component, the sandboxed detonator component, and the WAF component comprises:
monitoring service request messages received from the client device;
monitoring responses sent by the web application server;
monitoring context information of the web application as it operates in a target computing environment;
collecting behavior information from the web application;
analyzing the collected behavior information to recognize outlier usage of the web application; and
analyzing the outlier usage of the web application via the honeypot component in response to determining that the usage of the web application is an outlier.

5. The method of claim 1, wherein analyzing the usage of the web application by the client device via the combination of the honeypot component, the sandboxed detonator component, and the WAF component comprises:
routing the service request message to the honeypot component in response to determining that web application usage is an outlier usage that has a probability of being non-benign that exceeds a threshold.

6. The method of claim 1, wherein the honeypot component includes a replica of a target computing environment, the method further comprising:
exercising the web application in the replica of the target computing environment included in the honeypot component.

7. The method of claim 6, further comprising:
surreptitiously monitoring the web application as it operates in the replica of the target computing environment.

8. The method of claim 1, analyzing the usage of the web application by the client device via the combination of the honeypot component, the sandboxed detonator component, and the WAF component comprises:
confirming that web application usage is non-benign via the sandboxed detonator component.

9. The method of claim 1, further comprising:
coordinating, via a manager component, operations and interactions between the honeypot component, the WAF component, and the sandboxed detonator component.

10. A system, comprising:
a web application server;
a honeypot component;
a sandboxed detonator component; and
a Web Application Firewall (WAF) component,
wherein two or more of the honeypot component, the sandboxed detonator component, and the WAF component are configured to perform operations comprising:
analyzing a usage of a web application by a client device;
generating analysis results by analyzing the received service request message or a server response message sent by the web application server;
using the generated analysis results to identify non-benign web application usage; and
protecting the web application server from the non-benign web application usage.

11. The system of claim 10, wherein:
analyzing the usage of the web application comprises:
determining, via the WAF component, whether a web application usage associated with the received service request message is an outlier usage;
analyzing, via the honeypot component, the outlier usage to compute a probability value that identifies a likelihood that the outlier usage is non-benign;
determining, via the honeypot component, whether the computed probability value exceeds a threshold value;
analyzing the outlier usage via a sandboxed detonator component in response to determining that the computed probability value exceeds the threshold; and
analyzing the outlier usage via the WAF component in response to determining that the computed probability value does not exceed the threshold; and
protecting the web application server from the non-benign web application usage comprises:
protecting the web application server based on analysis results generated by either the sandboxed detonator component or the WAF component.

12. The system of claim 10, wherein the WAF component includes a behavior based security component.

13. The system of claim 10, wherein analyzing the usage of the web application by the client device comprises:
monitoring service request messages received from the client device,
monitoring responses sent by the web application server;
monitoring context information of the web application as it operates in a target computing environment;
collecting behavior information from the web application;
analyzing the collected behavior information to recognize outlier usage of the web application; and
analyzing the outlier usage of the web application via the honeypot component in response to determining that the usage of the web application is an outlier.

14. The system of claim 10, wherein analyzing the usage of the web application by the client device comprises:
routing a service request message to the honeypot component in response to determining that web application usage is an outlier usage that has a probability of being non-benign that exceeds a threshold.

15. The system of claim 10, wherein:
the honeypot component includes a replica of a target computing environment; and
one or more of the honeypot component, the sandboxed detonator component, and the WAF component are configured to perform operations comprising:
exercising the web application in the replica of the target computing environment included in the honeypot component.

16. The system of claim 14, further comprising:
surreptitiously monitoring the web application as it operates in the replica of the target computing environment.

17. A computing device, comprising:
means for analyzing a usage of a web application by a client device;
means for generating analysis results by analyzing the received service request message or a server response message sent by a web application server;
means for using the generated analysis results to identify non-benign web application usage; and
means for protecting the web application server from the non-benign web application usage.

18. The computing device of claim 17, wherein means for analyzing usage of the web application by the client device comprises means for analyzing usage of the web application by the client device via two or more components selected from a group comprising a honeypot component, a sandboxed detonator component, and a Web Application Firewall (WAF) component, the WAF component including a behavior based security component.

19. The computing device of claim 17, wherein:
means for analyzing usage of the web application by the client device comprises:
means for determining, via the WAF component, whether a web application usage associated with the received service request message is an outlier usage;
means for analyzing, via the honeypot component, the outlier usage to compute a probability value that identifies a likelihood that the outlier usage is non-benign;
means for determining, via the honeypot component, whether the computed probability value exceeds a threshold value;
means for analyzing the outlier usage via a sandboxed detonator component in response to determining that the computed probability value exceeds the threshold; and
means for analyzing the outlier usage via the WAF component in response to determining that the computed probability value does not exceed the threshold; and
means for protecting the web application server from the non-benign web application usage comprises:
means for protecting the web application server based on analysis results generated by either the sandboxed detonator component or the WAF component.

20. The computing device of claim 17, wherein means for analyzing usage of the web application by the client device comprises:
means for monitoring service request messages received from the client device,
means for monitoring responses sent by the web application server;
means for monitoring context information of the web application as it operates in a target computing environment;
means for collecting behavior information from the web application;
means for analyzing the collected behavior information to recognize outlier usage of the web application; and
means for analyzing outlier usage of the web application via a honeypot component in response to determining that the usage of the web application is an outlier.

21. The computing device of claim 17, wherein means for analyzing usage of the web application by the client device comprises:
means for routing a service request message to a honeypot component in response to determining that web application usage is an outlier usage that has a probability of being non-benign that exceeds a threshold value.

22. The computing device of claim 17, further comprising:
means for exercising the web application in a replica of a target computing environment included in a honeypot component.

23. The computing device of claim 22, further comprising:
means for surreptitiously monitoring the web application as it operates in the replica of the target computing environment.

24. The computing device of claim 17, wherein means for analyzing usage of the web application by the client device comprises:
means for confirming that web application usage is non-benign via a sandboxed detonator component.

25. The computing device of claim 17, further comprising:
means for coordinating operations and interactions between a honeypot component, a WAF component, and a sandboxed detonator component.

26. A non-transitory processor-readable medium having stored thereon processor-executable instructions configured to cause a processor of a computing device to perform operations comprising:
analyzing a usage of a web application by a client device;
generating analysis results by analyzing the received service request message or a server response message sent by a web application server;
using the generated analysis results to identify non-benign web application usage; and
protecting the web application server from the non-benign web application usage.

27. The non-transitory processor-readable medium of claim 23, wherein the stored processor-executable instructions are configured to cause a processor to perform operations such that analyzing the usage of the web application comprises analyzing the usage of the web application via two or more components selected from a group comprising a honeypot component, a sandboxed detonator component, and a Web Application Firewall (WAF) component, the WAF component including a behavior based security component.

28. The non-transitory processor-readable medium of claim 23, wherein the stored processor-executable instructions are configured to cause a processor to perform operations such that analyzing the usage of the web application further comprises:
monitoring service request messages received from the client device,
monitoring responses sent by the web application server;
monitoring context information of the web application as it operates in a target computing environment;
collecting behavior information from the web application;
analyzing the collected behavior information to recognize outlier usage of the web application; and
analyzing the outlier usage of the web application via a honeypot component in response to determining that the usage of the web application is an outlier.

29. The non-transitory processor-readable medium of claim 23, wherein the stored processor-executable instructions are configured to cause a processor to perform operations such that analyzing the web application comprises:
routing a service request message to a honeypot component in response to determining that web application usage is an outlier usage that has a probability of being non-benign that exceeds a threshold.

30. The non-transitory processor-readable medium of claim 23, wherein:
the stored processor-executable instructions are configured to cause a processor to perform operations further comprising:
coordinating, via a manager component, operations and interactions between a honeypot component, a WAF component, and a sandboxed detonator component;
exercising the web application in a replica of a target computing environment included in a honeypot component; and
surreptitiously monitoring the web application as it operates in the replica of the target computing environment; and
the stored processor-executable instructions are configured to cause a processor to perform operations such that analyzing the web application comprises:
confirming that web application usage is non-benign via a sandboxed detonator component.
